(19) United States
(12) Patent Application Publication
(10) Pub. No.: US 2009/0013934 A1
(43) Pub. Date: Jan. 15, 2009

(54) AUTOMATIC SEPARATION OF ANIMAL MILK

(76) Inventors: Heinz Francke, Oelde (DE); Beate Maassen-Francke, Oelde (DE)

Correspondence Address: Jeffrey W Smith;Smith Law Office, 440 Science Drive, Ste 302, Madison, WI, 53711, US

(21) Appl. No.: 11/660,787

(22) PCT Filed: Sep. 2, 2005
(86) PCT No.: PCT/EP05/09455

§ 371 Date: Sep. 18, 2008

(30) Foreign Application Priority Data
Sep. 3, 2004 (DE) 10 2004 042 658.9

(51) Int. Cl. A01J 5/007

(52) U.S. Cl. 119/14.02

(57) ABSTRACT

The invention relates to, inter alia, a method for determining a modified waiting period for a milk-producing animal treated with a veterinary medicament. According to said method, at least one quantity of milk is determined during at least one time interval following the administration of the veterinary medicament, said interval being shorter than a pre-determined waiting period. A milk yield for the waiting period is predicted from the quantity of milk. A modified waiting period is determined on the basis of the predicted milk yield and a milk yield for the waiting period pre-determined by the veterinary medicament. The inventive method enables MRL values to be surely and reliably maintained, such that milk is separated according to the modified waiting period.

The invention relates to a method for determining a modified waiting time for a milk-producing animal treated with a veterinary medicament, to a method for separating animal milk in a milking apparatus, to a device for determining a modified waiting time, and to an apparatus for separating animal milk in a milking apparatus.

Illnesses caused by bacteria also occur in animals and may lead to life-threatening diseases. They affect practically all the organ systems, for example the lungs, stomach and intestines, the urinary organs, the genital organs, and the skin. The pathogens may be transmitted in different ways. Thus, bacteria may be transmitted directly through smear infections and droplet infections, for example by direct contact of infected animals, or by carriers. Particularly in acute systemic disorders with fever, prompt and specifically targeted treatment of animals with suitable veterinary medicaments is absolutely imperative.

Despite constant improvements in the measures taken to prevent disease, for example through animal hygiene and housing hygiene, vaccination, etc., diseases cannot be ruled out, not even in animals that are kept in large herds. It is therefore necessary that diseased animals kept in a herd are identified at an early stage and are given appropriate treatment. Because of the different diseases that exist and the different causative agents of such diseases, it is necessary to use veterinary medicaments that have different mechanisms of action and ranges of action. For this purpose, the veterinary medicines are made available in suitable presentations. In veterinary medicine, medicaments are mainly given by oral, parenteral, intravenous, intramuscular or subcutaneous administration.

Every medicinal agent in a veterinary medicament in the European Union will undergo pharmacology and toxicology tests before being placed on the market. Possible undesired side effects on individual organ systems are deduced from the toxicity studies. Moreover, these tests form the basis for determining the maximum residue limits in foodstuffs produced from the treated animal.

Within the European Union, the basis for the procedure for establishing maximum residue limits (MRL) for veterinary medicines is regulation No. 2377/90/EEC on “stipulating a Community procedure for the establishment of maximum residue limits of veterinary medicaments in foodstuffs of animal origin”. The MRLs are used, on the one hand, as values for evaluation in the context of chemical analytical study and residue control of foodstuffs of animal origin. On the other hand, in approval procedures for medicaments on the basis of the MRLs, so-called waiting times are stipulated, i.e. the time interval in which, after treatment of an animal, no foodstuff may be obtained from this animal.

After each use of veterinary medicaments, a residual amount remains for a certain period of time in the animal's body. To ensure that these residues in animals do not endanger the consumer, these residual amounts must not exceed specified maximum limits in food-producing animals. The MRL is a limit value which ensures consumer protection in the food industry within Europe. The MRL is derived from the acceptable daily intake (ADI) of a medicinal agent. This represents the residual amount that a human can ingest with food every day over a lifetime without suffering harm. The MRLs are set, in light of the pharmacokinetics of the veterinary medicament, such that the ADI value is not exceeded even when certain amounts of food are consumed daily by an adult.

If an animal is treated with a medicament, a certain period of time elapses before any medicinal agent is degraded by the organism and excreted. It is therefore necessary to wait until levels fall below the MRL. During this time, milk obtained from a milk-producing animal is set aside.

Particularly in milking systems in which the milking frequency, that is to say the number of milking session within a certain time interval, is not predefined, there is a danger that, despite compliance with the waiting time after administration of a veterinary medicament, there will be high residue levels of the medicinal agent in the milk, with the result that the MRLs cannot be complied with.

Starting out from this, it is an object of the present invention to make available a method for determining a modified waiting time for a milk-producing animal treated with a veterinary medicament, by means of which method it is possible to increase the certainty with which maximum residue limits for veterinary medicaments are complied with.

According to the invention, this object is achieved by a method for determining a modified waiting time for a milk-producing animal treated with a veterinary medicament, said method having the features of claim 1. Advantageous developments and embodiments of the method are the subject matter of the dependent claims.

In the method according to the invention for determining a modified waiting time for a milk-producing animal treated with a veterinary medicament, it is proposed that at least one quantity of milk is recorded within at least one time interval following the time of administration of the veterinary medicament, said time interval being shorter than a predefined waiting time. A milk yield for the waiting time is predicted on the basis of the quantity of milk. Thereafter, a modified waiting time is determined on the basis of the predicted milk yield and on the basis of a milk yield for the waiting time predefined by the veterinary medicament.

The method according to the invention increases the certainty of the MRLs being complied with, since, in animals whose predicted milk yield for the waiting time is substantially less than a milk yield for the waiting time predefined by the veterinary medicament, the modified waiting time is greater than the predefined waiting time.

The method according to the invention affords the possibility of specifying modified waiting times for individual animals. In addition, it is also possible, by means of the method according to the invention, to determine modified waiting times specific to veterinary medicaments.

During the waiting time, the milk from the animal treated with a veterinary medicament has to be separated. This means that the animal's milk cannot be used. Unused milk from animals has a negative impact on the economic viability of a dairy operation. The method according to the invention for determining a modified waiting time also affords the possibility of improving the economic viability of a dairy operation. The modified waiting time determined in light of the milk yield of an animal can be shorter than the predefined waiting time. The animal's milk can be made use of after the modified waiting time has elapsed, possibly taking a safety factor into consideration.

According to an advantageous embodiment of the method, it is proposed that, in addition to the quantity of milk, the milking frequency is also recorded within the at least one time interval. Such a procedure is advantageous especially for those dairy operations in which the animals are able to go to a milking stall as and when they wish. It is also possible to use the established milking frequency to assign animals to a group, for example, which needs to be milked several times a day. The milking frequency with which an animal is milked can be predefined as a function of a veterinary medicament. It is also possible, in addition to this, to predefine the milking frequency as a function of the state of health of the animal. The milking frequency can also be made dependent on a large number of other parameters, for example the state of health of the udders, the conductivity of the collected milk, the fat or protein content, the number of somatic cells, etc.

According to another advantageous embodiment of the method, it is proposed that the modified waiting time be determined after each milking session. In particular, the quantity of milk is determined, or the quantity of milk and the milking frequency are determined, at each milking session. By means of this advantageous procedure, the modified waiting time is rendered dynamic, since it is adapted to the actual circumstances. Thus, for example, on the basis of the values determined after administration of a veterinary medicament, it is possible to determine a modified waiting time which is shorter than the predefined waiting time. Through other data that follow from other milking sessions, the modified waiting time may in some cases be greater than the predefined waiting time, thereby increasing the certainty of the MRLs being complied with.

Different veterinary medicaments are used depending on the clinical picture. It is also known that, for a specified clinical picture, medicaments from different manufacturers are available which contain essentially the same active substance. For documentation of the waiting times that have been complied with by individual animals, it is proposed that the animal-specific waiting time is stored. It is particularly advantageous if, for the animal-specific waiting time, the associated profile of the milk yield is also stored.

In modern dairy operations, data specific to each animal are stored in a herd management system. These data can also include the veterinary measures that have been implemented. In addition, it is possible for data concerning milk yield, milking frequency and other details of an animal to be stored in the herd management system. Given the availability of these data, it is proposed that a modified waiting time be predicted, at the time of administration of a veterinary medicament, on the basis of historical data.

In particular, the prediction of a milk yield for the waiting time can be made, at the time of administration of a veterinary medicament, on the basis of past milk yields, in particular the quantity of milk and/or the milking frequency. This predicted milk yield for the waiting time can be provided with an additional safety factor.

It is proposed, preferably, that factors specific to individual animals or even factors related to herds are taken into account in the prediction of a milk yield for the waiting time. The lactation state of the animal is preferably taken into consideration for predicting a milk yield on the basis of past milk quantities.

According to another advantageous embodiment of the method, it is proposed that the modified waiting time be predicted, at the time of administration of a veterinary medicament, on the basis of a modified waiting time or modified waiting times already determined at an earlier time. It is also possible here to take account of whether the same veterinary medicament is being presently administered as at an earlier time. It is also possible to take into account whether different medicaments have been used, but ones containing the same active substance.

The method according to the invention for determining a modified waiting time also opens up the possibility of constructing a database from which historical data can be used to determine future modified waiting times. In this connection, features of the animals, for example the lactation state, milk yield, breed, feeding habits, etc., can also be taken into account in determining the modified waiting time.

It is also an object of the present invention to make available a method for separating animal milk in a milking apparatus for milking at least one animal treated with a veterinary medicament, which method makes separation of the animal milk more reliable.

According to the invention this object is achieved by a method for separating animal milk in a milking apparatus for milking at least one animal treated with a veterinary medicament, having the features of claim 10. Advantageous embodiments and developments of the method are the subject matter of the dependent claims.

The method according to the invention for separating animal milk in a milking apparatus for milking at least one animal treated with a veterinary medicament, said animal having at least one identification means which is intended to be read by a reading device, is characterized in that the animal is identified prior to a milking session and its milk is separated off if a time period between the treatment and the identification is shorter than a modified waiting time, which was determined in accordance with one of claims 1 through 9. The separation of the animal milk takes place safely and reliably, since an animal is first of all identified and, depending on the allocation of the animal, whether it has a positive or negative health status, separation of the milk then takes place or not.

According to another advantageous embodiment of the method, it is proposed that at least some of the milk that has been separated off is analyzed. In this way, additional information can be obtained in respect of the determination of a modified waiting time. In particular, the modified waiting time can be altered depending on the result of the analysis of some of the animal milk. The analysis results can also be used for renewed determination of the modified waiting time.

It is also an object of the present invention to make available a device for determining a modified waiting time.

According to the invention, this object is achieved by a device having the features of claim 13. Advantageous embodiments and developments of the device for determining a modified waiting time form the subject matter of the respective dependent claims.

To determine a modified waiting time for a milk-producing animal treated with a veterinary medicament, a device is proposed which comprises a recording unit for recording at least one quantity of milk. A device for determining a milk yield for a waiting time predefined by the veterinary medicament is provided. In addition, the device for determining a modified waiting time comprises a means for determining a modified waiting time on the basis of the predicted milk yield and on the basis of a milk yield for the waiting time predefined by the veterinary medicament.

The device for determining a milk yield and the means for determining a modified waiting time can, for example, take the form of a data processing installation, in particular a computer.

An embodiment of the device is preferred in which the recording unit is suitable for recording a quantity of milk and/or a milking frequency.

According to another advantageous embodiment of the device, it is proposed that at least one memory is provided for storing at least the modified waiting time specific to each animal. An embodiment of the device is preferred in which it is designed with a central database.

To be able to check the compliance of the MRLs at modified waiting times too, it is proposed, according to another advantageous embodiment of the device, that the latter has an analysis device for the animal milk.

According to another inventive concept, an apparatus for separating animal milk in a milking apparatus for milking at least one animal treated with a veterinary medicament is proposed, said apparatus having at least one identification means for an animal, and a reading device for recognizing the identification means. The apparatus according to the invention comprises a memory unit for storing animal-specific data. To check whether the milk of the identified animal is to be separated off if a time period between the treatment and the identification is shorter than a modified waiting time which was determined in accordance with one of claims 1 through 9, a comparison device is proposed.

The apparatus according to the invention is also characterized in that at least one means is provided which, as a function of the result of the comparison, is controlled in such a way that the animal's milk either passes into a conduit for consumable milk or into a conduit for non-consumable milk. Said means is preferably in the form of at least one valve. It is proposed in particular that the valve is a multi-way valve.

Further details and advantages of the invention will be explained on the basis of the illustrative embodiments shown in the drawing, without the subject matter of the invention being limited to these specific illustrative embodiments.

In the drawing:

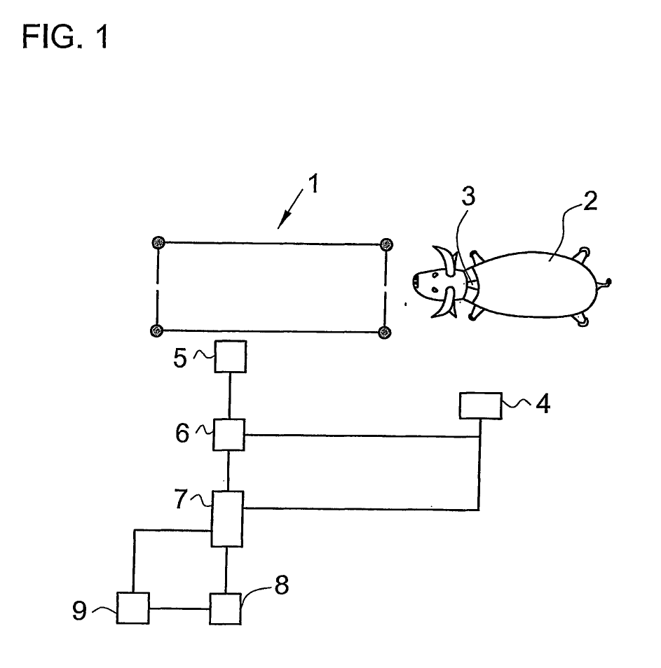

FIG. 1 is a schematic representation of an apparatus for separation of animal milk,

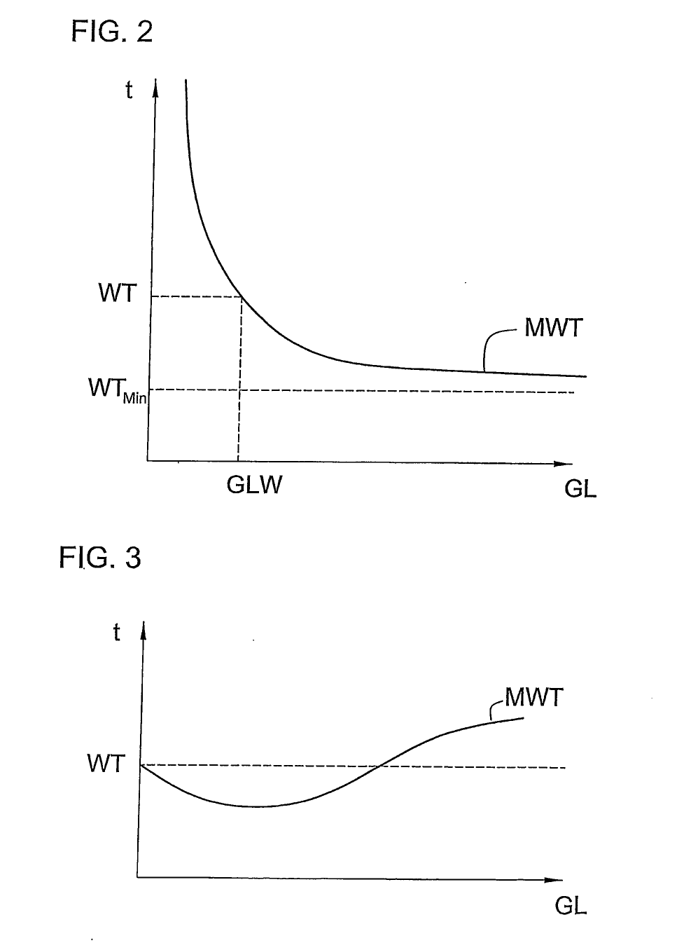

FIG. 2 is a diagram showing the profile of a modified waiting time as a function of milk yield, and

FIG. 3 shows the profile of a modified waiting time for an animal during a treatment.

FIG. 1 is a schematic representation of an apparatus for separating animal milk in a milking apparatus for milking at least one animal treated with a veterinary medicament. Reference number 1 designates a milking stall at which an animal 2 can be milked. The animal 2 has an identification means 3. The identification means 3 is in the form of a passive transponder arranged on the neck of the animal 2. The identification means can involve a variety of very different identification means. For example, it can be in the form of a leg responder, boli or the like. The animal 2 is identified before entering the milking stall 1. The identification is effected via a reading device 4. The reading device can be connected to a herd management system (not shown) or to a milking apparatus control system.

The identification of each animal can be made, for example, in the approach path to a milking apparatus, for example. It is also possible for the identification to be made at the milking stall. However, preference is given to identification of the animals on the approach to the milking apparatus, because the animals whose milk is to be separated off can then be gathered into a group and milked after the animals whose milk is not to be separated off. This measure increases the degree of certainty that milk which is to be separated off does not inadvertently get into a tank for consumable milk.

At the milking stall 1, the animal is milked by means of a milking machine (not shown). The quantity of milk that the animal produces during a milking session is recorded by means of a recording unit 5.

The identification means 3 preferably also includes animal-specific information, for example the time of administration of the veterinary medicament, and a waiting time associated with the veterinary medicament. These details too are recorded via the reading device 4. If appropriate, these details can also be read out from the herd management system.

By means of a device 6 which is connected to the recording unit 5, a milk yield is determined for a waiting time predefined by the veterinary medicament. The data determined by the device 6 are sent to a means 7 for determining a modified waiting time on the basis of the predicted milk yield and on the basis of a milk yield for the waiting time predefined by the veterinary medicament. This modified waiting time can also be transferred to the reading device 4, by means of which this information is transmitted to the identification means 3. The modified waiting time WT is also transmitted to the herd management system.

The animal-specific data can also be stored in a memory unit 8.

To check whether the milk of the identified animal is to be separated off if a time period between the treatment and the identification is shorter than a modified waiting time, a comparison device 9 is provided. As a function of the result of the comparison, the animal's milk is either passed into a conduit for consumable milk or into a conduit for non-consumable milk.

FIG. 2 shows the profile of a modified waiting time MWT as a function of the milk yield GL. If the milk yield of an animal is smaller than one for a waiting time WT predefined by the medicament, the modified waiting time increases, which leads to increased safety in respect of compliance with the MRL values. Such a situation can arise especially if the quantity of milk and/or the milking frequency of the treated animal lead to the milk yield of this animal being smaller than the milk yield GLW.

If the milk yield of the animal is greater than the milk yield GLW associated with the waiting time WT, the modified waiting time can then assume lower values, since compliance with the MRL values is guaranteed also at higher milk yields. For technical safety reasons and/or for legal reasons, it may be appropriate to set a minimum waiting time which has to be met irrespective of the size of the milk yield.

The profile of the modified waiting time MWT may differ. It may also be dependent on the veterinary medicament and on the active substance. There is also the possibility of the pharmacodynamics and the pharmacokinetics differing from animal to animal.

FIG. 3 is a diagram showing the profile of the modified waiting time MWT as a function of the milk yield. The milk yield is determined anew after each milking session. A new modified waiting time is determined therefrom. FIG. 3 shows that the modified waiting time initially drops below the waiting time. The reason for this can be seen in the fact that the milk yield in the first milking sessions is relatively high, whereas in subsequent milking sessions the milk yield falls, such that the expected milk yield means the modified waiting time MWT is greater than the waiting time WT.

The method according to the invention and the apparatus according to the invention are suitable for milk-producing animals. The invention can be applied especially in connection with the milking of cows, sheep, goats, yaks, dromedaries, mares or similar milk-producing animals.

The method and the device are also suitable for partially automated milking installations, automatic milking installations, and robot-assisted milking installations.

### LIST OF DESIGNATIONS

1 milking stall
2 animal
3 identification means
4 reading device
5 recording device
6 device
7 means
8 memory unit
9 means for determining a modified waiting time

1. A method for determining a modified waiting time (MWT) for a milk-producing animal treated with a veterinary medicament, said method comprising the following steps:
a) recording at least one quantity of milk produced by the animal within a time interval following the time of administration of the veterinary medicament, said time interval being shorter than a predefined waiting time (WT);
b) predicting a milk yield (GL) for the waiting time (WT) on the basis of the quantity of milk; and
c) determining a modified waiting time (MWT) on the basis of the predicted milk yield (GL) and on the basis of a milk yield for the waiting time (WT) predefined by the veterinary medicament.

2. The method as claimed in claim 1, in which the milking frequency is also recorded within the at least one time interval.

3. The method as claimed in claim 1, in which the quantity of milk is determined, or the quantity of milk and the milking frequency are determined, at each milking session, and the modified waiting time (MWT) is determined after each milking session.

4. The method as claimed in claim 1, in which the modified waiting time specific to each animal is stored.

5. The method as claimed in claim 4, in which the milk yield profile associated with the animal-specific waiting time is stored.

6. The method as claimed in claim 1, in which a modified waiting time (MWT) is predicted, at the time of administration of a veterinary medicament, on the basis of historical data.

7. The method as claimed in claim 6, in which a prediction of a milk yield for the waiting time is made, at the time of administration of a veterinary medicament, on the basis of previous milk yield, in particular the quantity of milk and/or the milking frequency.

8. The method as claimed in claim 7, in which at least the lactation state of the animal is taken into consideration for the prediction of a milk yield on the basis of the quantity of milk determined in the past.

9. The method as claimed in claim 6, in which the modified waiting time (MWT) is predicted, at the time (T0) of administration of a veterinary medicament, on the basis of modified waiting times already determined at an earlier time.

10. The method of claim 1, wherein milk from an animal treated with a veterinary medicament is separated off from milk of other animals if a time period between the treatment and the identification is shorter than a modified waiting time.

11. The method as claimed in claim 10, in which at least some of the milk that has been separated is analyzed.

12. The method as claimed in claim 11, in which the modified waiting time is determined anew as a function of the result of the analysis.

13. A device for determining a modified waiting time (MWT) for a milk-producing animal treated with a veterinary medicament, comprising:
a recording unit for recording at least one quantity of milk;
a device for determining a milk yield for a waiting time (WT) predefined by the veterinary medicament; and
means for determining a modified waiting time (MWT) on the basis of the predicted milk yield and on the basis of a milk yield for the waiting time (WT) predefined by the veterinary medicament.

14. The device as claimed in claim 13, characterized in that the recording unit records a quantity of milk and/or the milking frequency.

15. The device as claimed in claim 13, characterized in that at least one memory is provided for storing at least the modified waiting time specific to each animal.

16. The device as claimed in claim 13, characterized in that a central database is provided.

17. The device as claimed in claim 13, characterized by an analysis device.

18. An apparatus for separating animal milk in a milking apparatus for milking at least one animal treated with a veterinary medicament, characterized by
at least one identification means for an animal;
at least one reading device for recognizing the identification means;
a memory unit for storing animal-specific data; and
a comparison device for checking whether the milk of the identified animal is to be separated off if a time period between the treatment and the identification is shorter than a modified waiting time, and by at least one means which, as a function of the result of the comparison, is controlled in such a way that the animal's milk either passes into a conduit for consumable milk or into a conduit for non-consumable milk.

19. The apparatus as claimed in claim 18, characterized in that the means comprises at least one valve.
